(19) United States
(12) Patent Application Publication
(10) Pub. No.: US 2002/0018211 A1
(43) Pub. Date: Feb. 14, 2002

(54) System and method to detect the presence of a target organism within an air sample using flow cytometry

(76) Inventor: Clifford A. Megerle, Manassas, VA (US)

Correspondence Address: Andrew C. Aitken, VENABLE, BAETJER, HOWARD & CIVILETTI, LLP, Post Office Box 34385, Washington, DC, 20043-9998, US

(21) Appl. No.: 09/875,229

(22) Filed: Jun. 7, 2001

Related U.S. Application Data
(60) Provisional application No. 60/209,787, filed on Jun. 7, 2000.

(51) Int. Cl. G01N 21/00

(52) U.S. Cl. 356/440

(57) ABSTRACT

A system for describing a target organism is disclosed (1) that includes a flow cytometer that receives a liquid analyte sample; and (2) a processor. The cytometer includes a laser, a flow cell for passing the analyte past a beam of light emitted from the laser, a first photodetector for detecting the peak intensity of light emitted from the analyte at a predetermined wavelength and then generating a signal, a second photodetector for detecting the duration of emitting light and generating a second signal, the second signal reflecting the size of material in the analyte. The processor compares data from the first and second signals, where the comparison defines a region R1 having a minimum and maximum value for the first signal and minimum and maximum value for the second signal, and sets a threshold level of counts in the region R1 using data from a first background measurement. The processor then compares a second measurement to the threshold value to determine if the threshold value is exceeded.

The present invention relates to an improved manner in which to detect the presence of harmful or pathogenic biological materials using flow cytometry techniques. The applicant claims the benefit of U.S. application Ser. No. 60/209,787 filed on Jun. 7, 2000.

### BACKGROUND OF THE INVENTION

Flow cytometry is a technique used for both qualitative and quantitative analysis of sample solutions that contain cellular material, primarily by optical means. In general, the technique employs the detection and analysis of light that is either reflected or emitted from either the intracellular components or structural features of cells. The technique takes advantages of the fact that different cells have different sizes and unique structural characteristics such as surface markers that will manifest detectable characteristics. The technique can also take advantage of the antibody antigen binding. For example a labeled antibody can bind with a corresponding unique antigen or protein on the surface or within a particular cell. Accordingly, the flow cytometry has a number of applications including diagnostic and/or prognostic uses. Further, since different cell types can be distinguished by quantitating structural features, flow cytometry can be used to count cells of different types in a mixture. By attaching a charge to specific types of cells, the technique can also be used to separate specific types of cells. Commercially available flow cytometers make measurements one cell at a time but can process thousands of cells in a few seconds. This characteristic of flow cytometry allows for the rapid feedback of information from the sample to the technician.

In order to employ flow cytometry the sample to be analyzed must be provided in a liquid medium. Particulate matter suspended in air can be captured in a liquid solution using a cyclone or impinger. The sample material is then dispersed in a single cell or monodisperse suspension and labeled to form an analyte. Next the cells are then allowed to pass in a continuous fluid steam so that the cells pass single-file through a laser beam. As each cell passes through the laser, a portion of the light is absorbed and other light is scattered. Some cells may also emit fluorescent light that has been excited by the laser. The cytometer can measure a number of parameters simultaneously for each cell including (1) low or small angle, forward scatter intensity (which is approximately proportional to cell diameter) (2) orthogonal (90 degree) scatter intensity (which reflects quantity of granular structures within the cell and indicators of texture or physical complexity of an organism) and (3) fluorescence intensities. The intensity of the light can be measured at more than one wavelength. Light from the laser is either reflected or excites the label which is then detected by a photodetector. Fluorescence intensities are typically measured at several different wavelengths simultaneously for each cell that can be used to determine the quantities of specific components within the cells. Thus one technique involves the combination of cells with fluorescent antibodies that can be used to determine presence and the densities of specific surface receptors. Labeling using antibodies allows for the identification of specific cell types. In each of the measurement techniques the signal from the detectors is typically segregated to a specific value, converted from an analog signal to a digital signal and then further processed.

By making them fluorescent, the binding of viruses to surface receptors can be measured. Intracellular components can also be reported by fluorescent probes, including total DNA/cell (allowing cell cycle analysis), newly synthesized DNA, specific nucleotide sequences in DNA or mRNA, filamentous actin, and any structure for which an antibody is available. Flow cytometry can also monitor rapid changes in intracellular free calcium, membrane potential, pH, or free fatty acids.

Accordingly, light that is reflected can be used to the number and size and surface characteristics of cells. In addition to cell determination of cell size, more versatile research instruments employ fluorescence, and hence may be distinguished as flow cytofluorometers. Information from the characteristics of the light scatter can be used to exclude dead cells, cell aggregates, and cell debris from the fluorescence data. Instruments for performing flow cytometry are commercially available from Becton-Dickinson and Coulter Electronics as well as others.

### SUMMARY OF THE INVENTION

The present invention is directed to a manner in which to use flow cytometry to determine a threshold level indicating the likely presence of a target biological organism, and more particularly to the anthrax bacteria or biological organism having similar characteristics to the anthrax bacteria, in an air sample. In the preferred embodiment of this invention, the airborne target is collected by a wet-walled cyclone into a liquid medium. The liquid medium or analyte is then labeled with pre-selected florescent dyes that have an affinity for the target organism. Using a commercially available flow cytometer, the instrument delivers the cell suspension to a flow cell where the measurements can take place. The measurement requires breaking the stream into uniform-sized droplets to separate individual cells in the flow cell. Within the flow cell laser optics direct specific wavelength light to the suspension as it passes through the light beam. Light that is reflected or emitted is detected using a using a photodetector that generates a signal that corresponds to the intensity of the light. The signal generated by the photodetector is then converted from an analog signal to a digital signal. Finally, the digital signal is processed by a processor according to an algorithm for the purpose of detecting whether a predetermined threshold has been met. The threshold algorithm compares a pre-selected portion or region of the signal taken from the environment to a background signal. In the event that there is a significant and predetermined difference between the environmental signal and the background signal, the program will provide an output indicating that the threshold level has been exceeded.

### BRIEF DESCRIPTION OF THE DRAWINGS

FIG. 1 is a schematic representation of a wet-walled cyclone that is used in accordance with a preferred embodiment of the invention.

FIG. 2 is a schematic representation of an analytical flow cytometer.

FIG. 3 is a representative dot plot of a background air sample showing a region R1 that is used for the analysis.

FIG. 4 is as representative dot plot of a “puffer” sample of Bacilli from an air sample also showing region R1.

### DETAILED DESCRIPTION

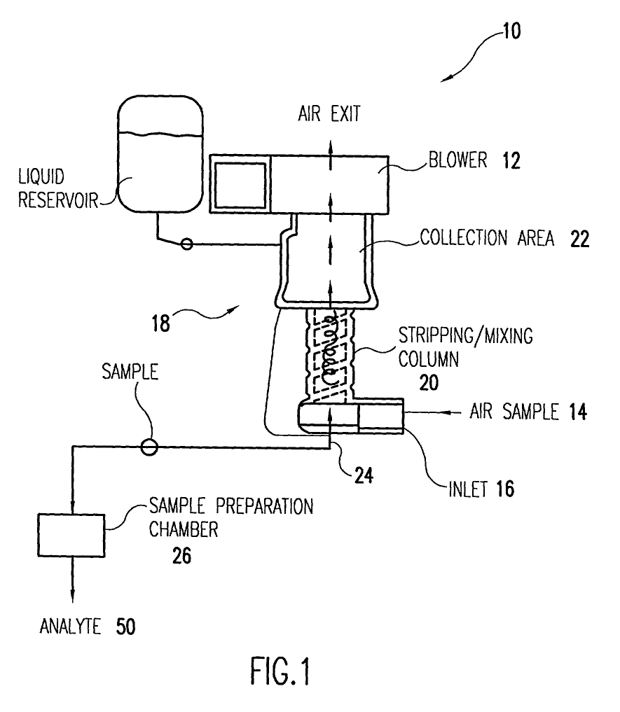

Now referring to FIG. 1, air from the environment containing particulate matter in the form of cellular material is sampled using a wetted wall cyclone sampler generally designated by the reference numeral 10. In the preferred embodiment, a wetted-walled cyclone sampler is employed. As depicted in FIG. 10, a blower 12 pulls an air sample though inlet 16 into a wetted-wall circular chamber 18. The blower and physical dimensions of the chamber causes the air stream to circulate in a cyclonic motion and provides an interface for gas/liquid partitioning of the analyte solution within the sample chamber. The sample air is first transported into a mixing chamber area 20 where the air flow will force intimate contact with water on the walls and in the air stream promoting further analyte extraction into the liquid phase. Centripetal force moves the particles toward the walls of the tube. Analyte may also be injected into the air stream to interface with the air sample. Upon exiting mixing chamber 20, the air sample will enter a collection section 22 that strips entrained water and exhausts the air stream. The interior water films from these sections are combined and a fraction of this volume is periodically withdrawn for analysis trough conduit 24. The remaining liquid can be recirculated to increase the analyte concentration. Cyclone samplers can be used to concentrate materials found in air samples in the parts per trillion to measurable amounts in a flow cytometer at a very rapid rate.

An alternative method of capturing particulate matter from an air sample is the use of impingers. These samplers work by drawing air through the liquid, causing the airborne particles to become suspended. Impingers are classified as single-stage and multi-stage. Single-stage impingers generally use a small flask that carries a wide inlet tube, the inner end of which is fused to a piece of capillary tube. The capillary tube dips at least into the flask and terminates at a point above the bottom of the flask. The capillary tube is a limiting orifice and thus controls the flow rate under suction from an attached pump. A multi-stage impinger confers advantages over the single-stage device by having a gentler flow, which is less damaging to particles. Further, multi stage impingers have a capacity to separate the retained particles by particle-size ranges. Sampled air passes through three liquid-filled chambers at three different speeds and particles collected in the first two chambers are impacted onto sintered glass discs that are washed by analyte liquid. In the third stage, particles are impinged tangentially into the liquid. Thus, multi-stage impingers have the advantage of minimizing damage to microbes and improving collection efficiency.

Referring back to FIG. 1, the sample is then prepared in a sample preparation chamber 26 and the analyte is transported to the flow cytometer for analysis.

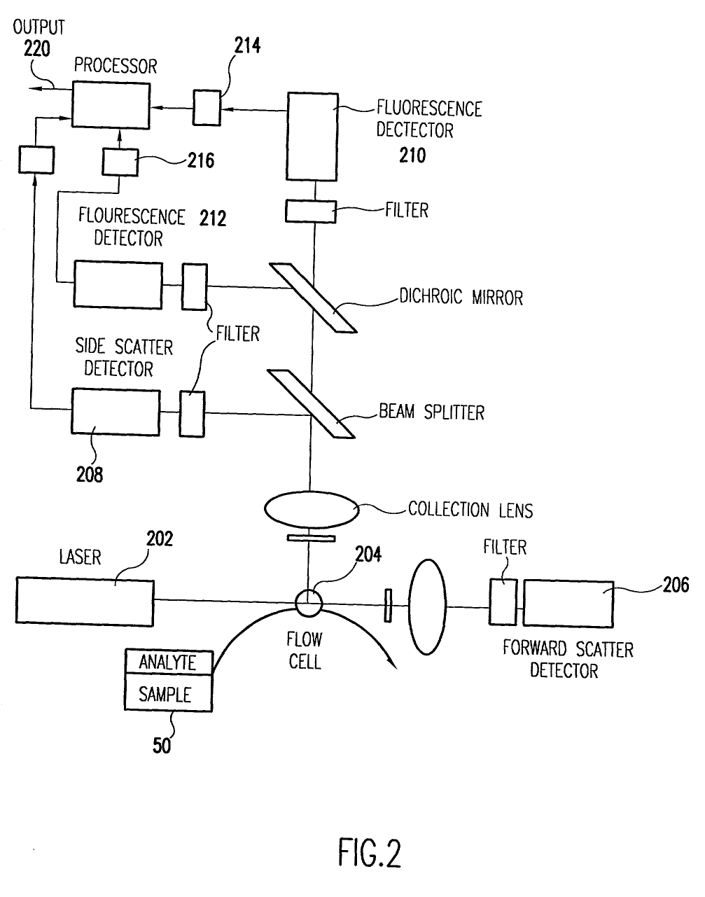

FIG. 2 depicts the basic components of the analytical flow cytometer. The optics deliver light from laser 202 in a beam that is focused across the flow cell 204 where the cells pass through in solution one cell at time. Commercially available equipment such as those sold by Becton Dickinson have detectors for both forward '206 and side scatter 208 light as well as multiple fluorescence detection channels that can simultaneously detect green, yellow-orange, and red light, the invention only requires two fluorescence detectors, fluorescence detector 210 and 212. The fluorescence detectors detect light in the wavelength that is emitted by the excited fluorochromes or dye and transmits the signal to an analog to digital converters 214 and 216 respectively. A computer 218 records data for thousands of cells per sample, and can display the data graphically in an output 220. An alternative output in the preferred embodiment is a signal indicating that a predetermined threshold level of a target organism has been exceeded.

The choice of fluorochrome tagged antibody or fluorescent dye used is influenced both by the application and the excitation wavelengths available. Dyes may differ from one another with respect to cell permeability, fluorescence enhancement upon binding nucleic acids, excitation and emission spectra, DNA/RNA selectivity and binding affinity. Thus each application requires experimentation to determine the optimal dye or combination of dyes. According to the preferred embodiment of the invention, the liquid sample from the sampler is prepared and labeled with a combination of the dyes Syto 15 and Syto 25. These dyes are nucleic acid dyes and are commercially available from Molecular Probes of Eugene, Oreg. These dyes will bind to the DNA of an organism and to other hydrophobic regions that exist in the sample. Upon successful binding these dyes are activated and will florescence more than a 100-fold increase in intensity compared to portions of the dye that remain unbound in the sample solution. Accordingly, the presence of fluorescence above the background signal provides an indication of the presence of a biological organism within the sample.

The present invention uses data from two photodetectors both adapted for the detection of fluorescence. The signals from the detectors are plotted in a “dot plot.” The first parameter or peak selected is the maximum intensity when a single organism passes through the flow cell of the flow cytometer. This maximum intensity output is an indication of how many dye molecules have attached to the DNA molecule, fragment or organism. Species with more dye that has bound to the DNA will exhibit a signal with a greater intensity or be brighter.

The second data parameter used in the analysis is referred to as the integrated fluorescence intensity over time divided by the peak intensity. This provides a measure of the time over which the fluorescence event occurs. If the width of the laser beam is small compared to the size of the fluorescence species, this time will be proportional to the size of the of the species. A very large species will fluoresce over the relatively long time that the cell requires to pass through the beam within the moving fluid in the flow cell. If the species is approximately the same size as the beam, the cell will pass quickly through the beam and the duration of the signal will consequently be shorter. Accordingly this element of the signal can be used to determine the size of the species. This feature further allows the size of the species to be accurately determined without measurement of the scattered light and thereby dispenses with the need for a forward-scattered light detector 206 that is typically used to perform this function. Likewise the side scatter detector 208 is not necessary to practice the analysis aspect of the invention.

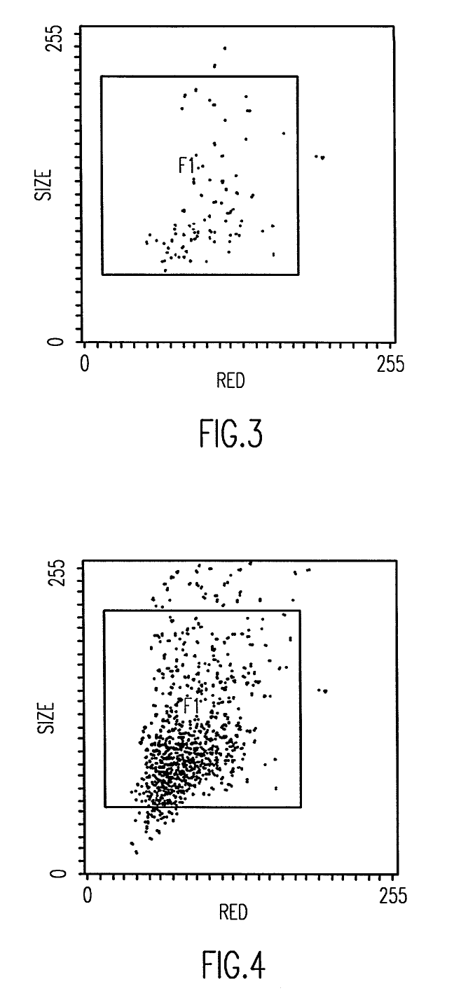

Data from the first and the second measurements are then plotted on an X Y graph as set forth in FIGS. 3 and 4. The X-axis is the peak fluorescence in the red channel detected by fluorescence detector 210. The Y-axis is the size parameter by fluorescence detector 212. The scales on the axis represent channel numbers, in this case the ranges of fluorescence and intensities are divided into 256 segments or bins (labeled 0-255). Data is assigned to the respective bins depending on their respective intensity and size using conventional processing techniques.

The manner in which the data from the fluorescence detectors is processed is set forth in the section below. The algorithm is designed to yield a positive detection in the event that counts within the predetermined region of the dot plot R1 exceed a threshold value. FIGS. 3 and 4 are representative dot plots for the background air and for a sample of air containing spore and vegetative bacterial of BG Bacillus subtilis var. niger. This bacterium is widely used to simulate Bacillus anthrasis spores because they share certain characteristics. In an alternative contemplated embodiment a fluorochrome tagged antibody that has an affinity to a target antigen is employed. As referred to above, the data from a flow cytometry detector is a measurement of the light intensity of a cell. This intensity can be scattered laser light or fluorescence emitted by a fluorochrome of fluorescent dye. Light is detected by a photodetector, typically a photomultiplier tube (PMT). The PMT converts light using an amplifier to a voltage or electrical output that is proportional to the original fluorescence intensity. These voltages, which are a continuous distribution, are then converted to a discrete distribution by an Analog to Digital converter (ADC) which places each signal into a specific channel depending on the level or intensity of fluorescence. The data from the PMT that has been converted to a digital signal and is then processed using an algorithm developed to detect for the threshold presence of the target organism.

Representative dot plots for background and aerosolized BG runs, respectively, are shown in FIG. 3 and FIG. 4. FIG. 3 shows data from the control run.

These four lines define the locations of the sides of the square labeled R1 shown in FIG. 3. Region R1 is the analysis region. The left hand side of the square R1 is defined by the left fluorescence channel number. This data is generated from the photodetector that captures florescence within the spectrum that has been emitted from the dye. The bottom of the square R1 is defined by the “bottom size channel number and the size data is captured by a separate photodetector 212. The right hand side of the square is defined by the “right fluorescence channel number,” and the top of the square is defined by the “top size channel number.”

In the example depicted in FIGS. 3 and 4 Region R1 is delimited by a lower fluorescence channel equal to 20, a bottom size channel equal to 50, an upper fluorescence channel equal to 180, and an upper size channel equal to 210. If the number of counts recorded within region R1 during the detector's analysis of a collected air sample is greater than the threshold value, the software reports a “positive detection” event. If, however, the number of counts recorded within region R1 is less than the threshold value, the software reports a “negative detection” event.

The algorithm automatically sets the threshold to a value determined from a measurement of counts within R1 obtained by a single sampling of the background air. In practice, the instrument operator performs a “single sample” analysis of the background air (no agent or simulant challenge) immediately after the conclusion of the startup sequence. The software then sets the threshold according to equation (1), below:

Threshold=A×(R1 background counts)+B (1)

where “A” and “B” are constants. Thus, the counts in region “R1” are multiplied by coefficient “A”, while counts equal to the value of “B” are added to the product to define the value for the threshold counts that will be used in all subsequent runs before shutdown.

In an example we use a value of A=1.0 and a value of B=170. If the counts in region R1 during the background run were 80, the software would set a counts value for the threshold equal to 250 counts, by use of equation (1).

The values for the “A” and “B” coefficients that are used by equation (1) to set the threshold value in Algorithm 2 were chosen to provide a threshold value that is approximately 3 standard deviations above the average value for background and blank runs.

The algorithm defines a rectangular region R1 within the dot plot within which the total number of counts during a single flow cytometric analysis will be counted. Further, the algorithm permits the determination of a threshold value counts within the region and determines whether the total during the analysis are less than equal or greater than the threshold value.

Because the fluorescence dye attaches to DNA or RNA the system serves a manner in which to quickly detect the presence of any biological organism. Because the dyes have a selectivity for nucleic acids, the detection system can work on fluids containing cellular components that have been lysed from cells as well as on intact cells. In the event that DNA is detected an output is provided that can alert to initiate further identification processes to ascertain the nature of the organism.

The foregoing specific embodiments and applications are illustrative only and are not intended to limit the scope of the invention. It is contemplated that the invention will functional and effective in other diverse application where it is desirable to determine if a predetermined level of particulate matter and more particularly a biological organism, in an air sample.

I claim:

1. A system to detect the presence of a predetermined amount of a specific target organism comprising a flow cytometer that can receive a liquid analyte sample, said cytometer comprising a laser, a flow cell for passing said analyte pass a beam of light emitted from said laser, a first photodetector for detecting the peak intensity of light emitted from said analyte at a predetermined wavelength and generating a signal, a second photodetector for detecting the duration of emitting light and generating a second signal, said second signal reflecting the size of material in said analyte, processing means to compare data from said first said and said second signals, said comparison comprising defining a region R1 said region comprising a minimum and maximum value for said first signal and minimum and maximum value for said second signal, setting a threshold level of counts in said region R1 using data from a first background measurement and then comparing a second measurement to said threshold value to determine if said threshold value is exceeded.

2. The system as recited in claim 1 further comprising air sampling means wherein said air sampling means draws a sample containing an organism from air and into a liquid solution and a means to prepare said sample by combined said sample with a fluorescent marker to form said analyte.

3. The system recited in claim 2 wherein said air sampling means comprise a wet-walled cyclone.

4. The system recited in claim 2 wherein said air sampling means comprises an impinger.

5. The system recited in claim 2 wherein said fluorescent marker is a fluorescent nucleic acid dye.

6. The system as recited in claim 2 wherein said dye comprises a combination of Syto 15 and Syto 25.

7. The system as recited in claim 1 wherein said target organism is bacillus anthrasis.

8. A method of determining whether there exists a predetermined threshold level of a target biological organism in an air sample comprising using flow cytometery data comprising defining a region R1 wherein said region is defined by a first upper and first lower limit comprising peak intensity values, defining a second upper and lower limit comprising size values, determining a maximum threshold value for data in said region R1 using a background measurement value and a constant, comparing subsequent environmental measurement values to said threshold value and providing an output in the event said threshold value is exceeded.

9. The system as recited in claim 8 wherein said target organism is bacillus anthrasis.

10. A computer readable medium containing instructions for detecting when a predetermine level of a pre-selected target organism is found in an air sample as reflected from data generated using a flow cytometer comprising defining a region R1 wherein said region is defined by a first upper and first lower limit comprising peak intensity values, defining a second upper and lower limit comprising size values, determining a maximum threshold value for data in said region R1 using a background measurement value and a constant, comparing subsequent environmental measurement values to said threshold value and providing an output in the event said threshold value is exceeded.

11. The computer readable medium as recited in claim 10 wherein said target organism is Bacillus anthrasis.
